(19) United States
(12) Patent Application Publication
(10) Pub. No.: US 2007/0038641 A1
(43) Pub. Date: Feb. 15, 2007

(54) Systems and methods for automated application updating

(76) Inventors: John Fawcett, Natick, MA (US); Jean Bredeche, Somerville, MA (US); Nader Akhnoukh, San Francisco, CA (US)

Correspondence Address: GOODWIN PROCTER LLP;PATENT ADMINISTRATOR, EXCHANGE PLACE, BOSTON, MA, 02109-2881, US

(21) Appl. No.: 11/501,459

(22) Filed: Aug. 9, 2006

Related U.S. Application Data
(60) Provisional application No. 60/706,603, filed on Aug. 9, 2005.

(51) Int. Cl. G06F 17/30

(52) U.S. Cl. 707/10

(57) ABSTRACT

This invention relates to a computer-based method and system for facilitating the retrieval, classification, and distribution of information. In one embodiment, a method for retrieving information includes defining command strings that include a URL and a token in a first software application, identifying a value for the token based on a research topic provided by a user, replacing the token in the command strings with the identified value, and transmitting the command strings to instantiations of a second software application, thereby allowing the instantiations of the second software application to retrieve data using its respective command string.

### CROSS-REFERENCE TO RELATED APPLICATIONS

This application claims priority to and the benefits of U.S. provisional patent application Ser. No. 60/706,603, filed Aug. 9, 2005, the entire disclosure of which is incorporated herein by reference.

### TECHNICAL FIELD

This invention relates to computer-based methods and systems for retrieving, organizing, and distributing data and, more particularly, to computerized methods and systems for retrieving, organizing, and distributing financial research data.

### BACKGROUND INFORMATION

The data available to individuals and institutions that monitor the global financial markets is wide-ranging. Investment professionals responsible for monitoring a particular company or industry sector may receive thousands of individual information items each day. Some of these information items may be presented in well-formatted and categorized formats from reliable and well-known sources such as financial statements filed with a stock exchange or the Securities and Exchange Commission, whereas other information items may be in the form of informal correspondence such as email or instant message, phone conversations, or face to face meetings. Furthermore, the application of numerous internet communications technologies to the research and information publishing process over the last decade has increased the volume of information available for analysis and the speed at which it is delivered. Often, opportunities to take advantage investment opportunities based on such information may exist for only a short time. Furthermore, the opportunity to act on information may not be concurrent with the arrival of the information itself. It is critical that investment professionals be able to monitor the numerous sources of information, discern pertinent information from irrelevant information, analyze it as quickly as possible and base decisions on the information as it arrives. Investment professionals must therefore be able analyze, in short periods of opportunity, historic information that is often difficult and time-consuming to recall or retrieve manually.

In addition to being able to understand information relating to a primary investment of interest—e.g. information relating to a specific company or industry—an effective investment professional must also immediately understand and appreciate so-called “derivative influences.” Examples of derivative influences might include information about a company's industry, a competitor, a supplier, a geographic region, or any subject that is somehow “related” to a primary investment. However, expanding the universe of relevant information to include these derivative influences often exponentially increases the volume of information an investment professional must review. As a result, investment professionals also expend an increasing portion of their research efforts discovering and exploring the derivative influences on investments. As the breadth of derivative influences increases, the rate at which a single investment professional can retain and recall the relationships among various research sources falls behind the rate the research information is produced and delivered. Further complicating the process, when an investment professional receives information pertaining to a particular investment, there may be numerous other investments that are indirectly affected by the information. This universe of affected entities in which one can invest is constantly changing, as companies are bought and sold, enter new markets, and forge new partnerships.

The same performance pressures apply to an investment firm as a whole. To be effective, all members of the firm want to share information in real time, and allow individuals to rapidly sort and distribute the massive amounts of information available. At the same time, the fundamental research basis of a firm's investment decisions are coming under greater scrutiny, and heightening the need for a clear research audit trail.

Therefore, to be effective, an investment professional must become increasingly productive with respect to the receipt, review, and recording of information such that he can adequately support the investments made by the firm.

### SUMMARY OF THE INVENTION

In general, the invention relates to computer based tools that allow users to simultaneously request, receive and review data from multiple sources that are delivered using a common application. Tools such as those described, for example, in co-pending U.S. patent application Ser. No. 10/712,076, “Systems and Methods for Retrieving Data” (incorporated by reference herein in its entirety) allow investment professionals to easily and simultaneously request, capture, store, retrieve and distribute a variety of information available in various forms (e.g., emails, instant messages, documents, newswire releases, etc.). While these tools provide ready access to an investment professional's internal research, meeting notes, emails, investment models and the like, there is a large amount of external information (e.g., on websites) to be gathered and referenced. To access this external information, an investment professional may navigate hundreds of web pages (sometimes daily) to gather information on companies, people and topics of interest that may affect various investments. Typically, an analyst concentrates his efforts on a particular entity of interest at one time—i.e., the current “focus” of his research, but often changes the focus of his research very quickly as events occur or priorities change. Therefore, the more quickly and more efficiently an investment professional can request, receive and review information from the multitude of sources, especially in rapidly changing environments, the more effectively he will be able to perform his duties.

Embodiments of the present invention facilitates use within a first application (such as a research application) of second, external application(s) (such as a web browsers, research software, etc.). The first application may be, for example, a desktop application, a server-based application, or some combination. The system facilitates increased productivity by allowing commands and terms used within the first application to cause the first application to automatically build and submit queries to the second application. The information presented by the second application thereby changes as the user navigates within the first application.

For example, this allows a user who changes research focus within a research application to also access external research data from, for example, web pages available over the Internet. If the user is using multiple instances (e.g., windows or tabs) of a web browser, each of those instances can be used to automatically access different information directed to the user's topical area of interest.

Further, in one embodiment, HTTP requests submitted using one instantiation of the embedded browser can cascade through other instantiations of the browser, as well as various modules in the desktop application. Thus, if multiple browser windows are open, changing the “focus” of one browser window (by, for example, entering a ticker symbol to request a market quote) will cause the other browser windows, as well as other linked modules within the application, to change their focus to the new entity. In that regard, multiple instances of the web browser can operate simultaneously, creating a “collection” of browser sessions, with update, request and/or refresh commands being executed in one, some or all of the instances, thus resulting in updated browsers, for example, accessed with a single command or user action.

Embodiments of the invention further provide or generate “tokens” that are used as elements of URLs such that the tokens are automatically replaced with user-supplied or application-supplied parameter values upon request. The token can be used in conjunction with multiple URLs such that when the application changes focus to a particular item (i.e., the user requests information about a particular company for example), the multiple instances of the web browser are automatically refreshed with pages relating to that item. The embedded browser can render any web document (e.g., HTML, images, PDF documents) as well as a host of local and networked resources (e.g., local disks, intranet sites, applications, shared folders, etc.). Multiple resources can be “joined,” thus creating groupings of applications, screens, sites, etc. though which single commands in one application propagate through the other applications in the group, even in cases in which their normal modes of operation do not support interaction.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of a system according to various embodiments of the invention.

FIG. 2 is a block diagram of a server in the system of FIG. 1 according to various embodiments of the invention.

FIG. 3 is a block diagram of a server and client in the system of FIG. 1 according to various embodiments of the invention.

FIG. 4 is a block diagram of a client in the system of FIG. 1 according to various embodiments of the invention.

FIG. 5 is a block diagram illustrating relationships among entities within the system in accordance with one embodiment of the invention.

FIG. 6 is an example of a string definition screen in accordance with one embodiment of the invention.

FIG. 7 is a screen capture of a join group definition screen in accordance with one embodiment of the invention.

FIG. 8 is a screen capture of an embedded browser application comprised of various joined application modules in accordance with one embodiment of the invention.

### DETAILED DESCRIPTION

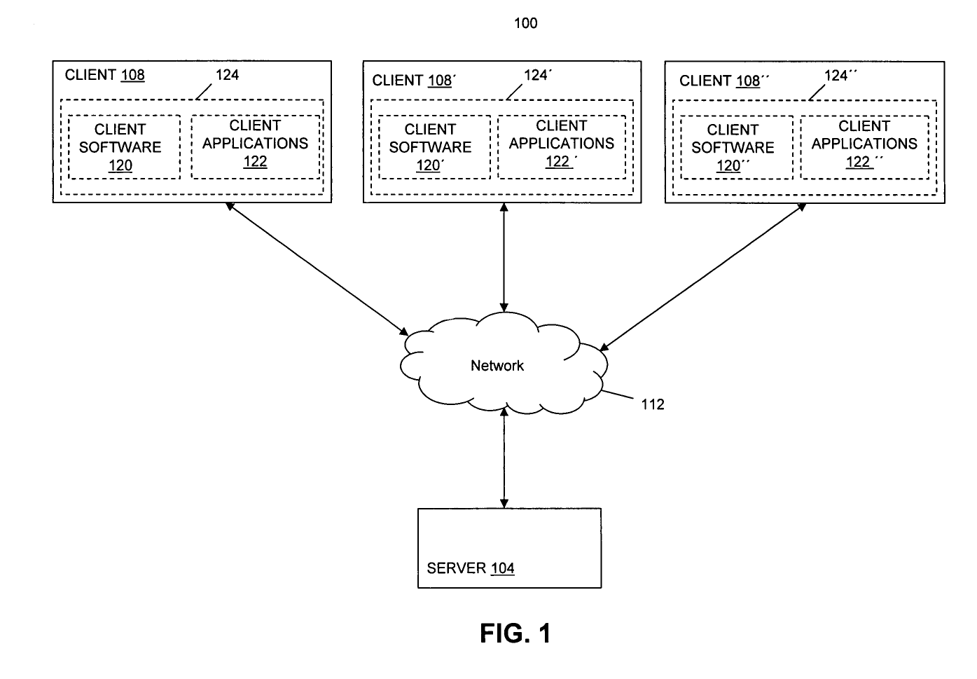

Referring to FIG. 1, in one embodiment, an information storage and retrieval system 100 includes at least one server 104, and at least one client 108, 108′, 108″, generally 108. As shown, the information storage and retrieval system 100 includes three clients 108, 108′, 108″, but this is only for exemplary purposes, and it is intended that there can be any number of clients 108. The client 108 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 108 may also be implemented on such hardware as a smart or dumb terminal, network computer, personal data assistant, wireless device, information appliance, workstation, minicomputer, mainframe computer, or other computing device that is operated as a general purpose computer or a special purpose hardware device solely used for serving as a client 108 in the information storage and retrieval system 100.

A communications network 112 connects the client 108 with the server 104. The communication may take place via any media such as standard telephone lines, LAN or WAN links (e.g., T1, T3, 56 kb, X.25), broadband connections (ISDN, Frame Relay, ATM), wireless links, and so on. Preferably, the network 112 can carry TCP/IP protocol communications, and HTTP/HTTPS requests made by the web browser and the connection between the client software 120 and the server 104 can be communicated over such TCP/IP networks. The type of network is not limited, however, and any suitable network may be used. Typical examples of networks that can serve as the communications network 112 include a wireless or wired Ethernet-based intranet, a local or wide-area network (LAN or WAN), and/or the global communications network known as the Internet, which may accommodate many different communications media and protocols.

Generally, clients 108 are operated by users of the system to receive, review, store and retrieve data regarding investment opportunities. In various embodiments, the client computer 108 includes client applications 122, client software 120, or both. One example of a client application 122 is a web browser application that allows the client 108 to request a web page (e.g. from the server 104 or a server operated by another company or individual) with a web page request. An example of a web page is a data file that includes computer executable or interpretable information, graphics, sound, text, and/or video, that can be displayed, executed, played, processed, streamed, and/or stored and that can contain links, or pointers, to other web pages. Other examples include electronic mail applications, as well as custom-developed desktop applications. In one embodiment, a user of the client 108 manually requests a web page from the server 104. Alternatively, the client 108 automatically makes requests with the web browser. Examples of commercially available web browser software are INTERNET EXPLORER, offered by Microsoft Corporation of Redmond, Wash., NETSCAPE NAVIGATOR, offered by AOL/Time Warner of Mountain View, Calif. and FIREFOX by the Mozilla Corporation of Mountain View, Calif.

In some embodiments, the client 108 also includes client software 120. The client software 120 provides functionality to the client 108 that allows a user to request and receive data using the methods described herein. The client software 120 may be implemented in various forms. For example, it may be in the form of a Java applet that is downloaded to the client 108 and runs in conjunction with one or more client applications 122. The client software 120 may be a standalone application written in C/C++, C#, Java or other appropriate client programming language. The client software 120 may be in the form of an application plug-in written in Visual Basic, C/C++, or C# that operates within a client application 122. Further, the client software 120 may be in the form of a standalone application, implemented in a multi-platform language such as Java, in a .Net Framework language such as C#, or in native processor executable code. In one embodiment, if executing on the client 108, the client software 120 opens a network connection to the server 104 over the communications network 112 and communicates via that connection to the server 104. The client software 120 and the web browser may be part of a single client-server interface 124; for example, the client software can be implemented as a “plug-in” to the web browser. The web browser is but one possible example of a client application, and others may include word processors, spreadsheets, operating system extensions, email clients, as well as others.

In some embodiments, an administrator operates the server 104, which provides data to the clients 108 upon request. In some embodiments, the server 104 operates without intervention from an administrator, for example, by executing chron jobs at periodic intervals, or executing batch routines based on the detection of operational occurrences such as equipment failures, power surges, or other monitored events. The server 104 is preferably implemented on one or more server class computers that have sufficient memory, data storage, and processing power and that run a server class operating system (e.g. SUN Solaris, GNU/Linux, MICROSOFT WINDOWS 2000, and later versions, or other such operating system). Other types of system hardware and software than those described herein may also be used, depending on the capacity of the device, the number of users and the amount of data received. For example, the server 104 may be part of a server farm or server network, which is a logical group of one or more servers. As another example, there may be multiple servers 104 that may be associated or connected with each other, or multiple servers may operate independently, but with shared data. As is typical in large-scale systems, application software could be implemented in components, with different components running on different server computers, on the same server, or some combination.

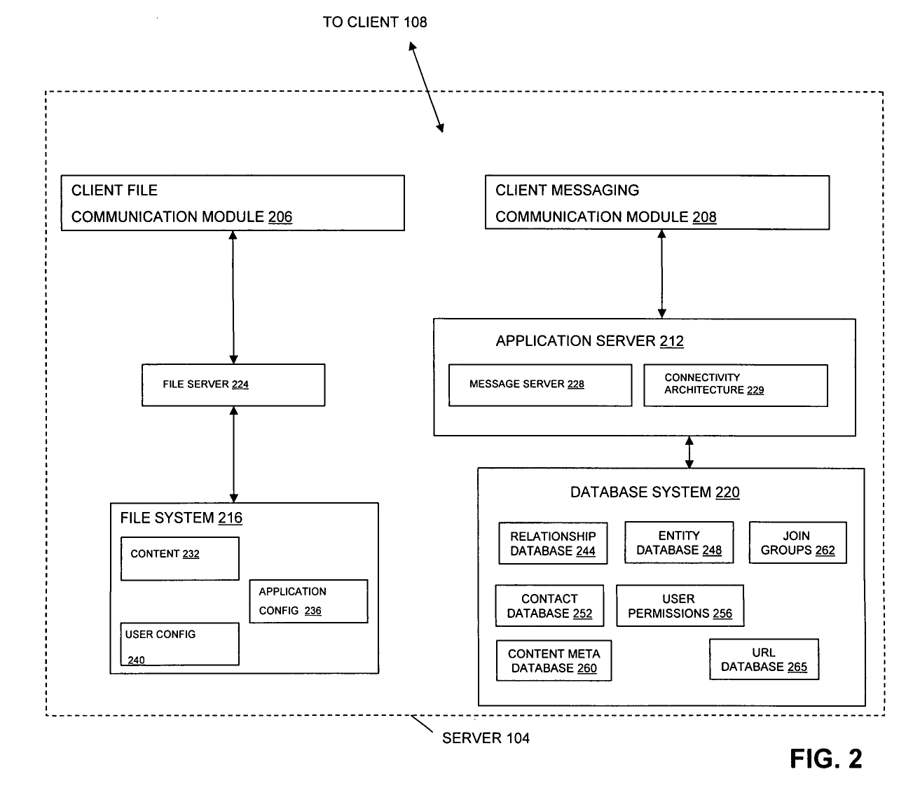

Referring to FIG. 2, in one embodiment, a server 104 includes a client file communication module 206 that is the interface for communication with clients 108 involving the transfer of files. In some instances, files may be transferred from the client 108 to the server 104, from the server 104 to the client 108, or both. The client communication module 206 can be implemented as software running on one or more servers, or may be implemented as a stand-alone server. In some embodiments, the client file communication module 206 can provide an interface both to client software 120 and to client applications 122, so that, for example, a user can access investment performance information through a web browser, a word processing application, or to review other data, and so on, while the client software 120 can be used for requesting and receiving additional information, or for defining parameters of the system. The interface to each of the client software 120 and the client applications 122 can be implemented separately or in combination. In other embodiments, the client file communication module 206 can also communicate using other protocols or mechanisms.

The server 104 may also include a client messaging communication module 208 as an interface for communication with clients 108 involving HTTP/S requests and responses, Java messages, SMTP messages, POP3 messages, instant messages, RSS feeds, as well as other electronic messages. In some instances, messages may be transferred from the client 108 to the server 104, from the server 104 to the client 108, or both. The client messaging communication module 208 can be implemented as software running on one or more servers, or may be implemented as a stand-alone server. In some embodiments, the client messaging communication module 208 can provide an interface both to client software 120 and to client applications 122, so that, for example, a user can send and receive e-mail, instant messages, and so on, while the client software 120 can be used for requesting and receiving additional information, or for defining parameters of the system. The interface to each of the client software 120 and the client applications 122 can be implemented separately or in combination. In other embodiments, the client messaging communication module 208 can also communicate using other protocols or mechanisms.

The client messaging communication module 208 communicates with the application server 212, which provides the main programming logic for the operation of the system. In one embodiment, the application server 212 is implemented as one or more application programs running on a server class computer, which may be the same or different computer as the client file communication module 206 or the client messaging communication module 208. The application server 212 receives requests for data stored in a database (such as an email, the historical performance of an investment vehicle, etc.) from users via the client messaging communication module 208, provides updated data to the client 108, and enforces system, application, and user level rules.

The server 104 also includes a database system 220, which stores data related to the investment opportunities, user permissions, industry data, and the like in one or more databases. For instance, the database server 220 may store information relating to entities defined by the users of the system, relationships among the entities, stored content, user information, server availability, and web traffic information. The database server 220 may also contain separate databases for relationships 244, entities 248, contacts of the users 252, user permissions and security information 256, and content metadata 260

In some embodiments, the database system 220 includes databases for storing, updating and provisioning join groups 262 and URL listings 265 to facilitate the automated updating of multiple applications or application modules based on user-provided inputs to other applications. The database server 220 provides data to the application server 212. An example of the database server 220 is the MySQL Database Server by MySQL AB of Uppsala, Sweden, the PostgreSQL Database Server by the PostgreSQL Global Development Group of Berkeley, Calif., or the ORACLE Database Server offered by ORACLE Corp. of Redwood Shores, Calif.

The server 104 also includes a file server 224 and a file storage system 216, which stores static data files 232 related to, for example, investment opportunities such as web pages, word processing documents, spreadsheets, PDF files, and others. The file server 224 receives requests for static data files from the client 108 via the client file communications module 206, transmits the request to the file storage system 216, and manages the status of the file once it is sent to the client 108. The file storage system 216 also stores application configuration information 236, such as server names, communication protocols, directory structures, and other aspects of the application that may be customized at the application, server, or system level. The file server 216 can also store user configuration information 240 (e.g., screen preferences, desktop layout preferences, join groups, menu options, security and administrative information, etc.). Such functional aspects of the application may be applied across an organization or customized and stored for individual users. In one embodiment, the file storage system 216 stores only data files, while file metadata such as the file location, the author, the creation date, file revision history and other metadata are stored in the content metadata DB 260.

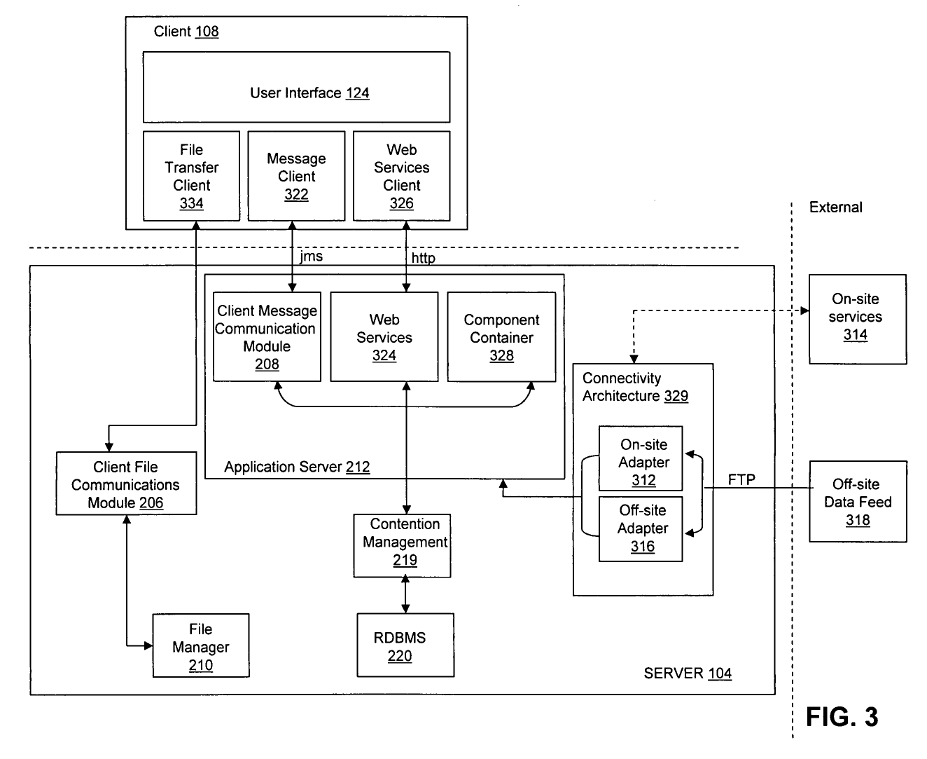

Referring to FIG. 3, in one embodiment, the client 108 includes a message client module 322, a web services client 326, and file transfer client module 334. The message client module 322 receives messages via the Java messaging service or other similar communications service from the application server 212 via the client messaging communications module 208. Upon receiving a message from the client messaging communications module 208, the message client 322 facilitates the display of the message on the user interface 124. The web services client module 326 facilitates receiving data from the application server 212 via a web services server module 324 such as the Apache Axis Web Services software via HTTP or some similar protocol. Both the web services module 324 and the client message communication module 208 publish data, for example, in XML format such that data may be automatically received by the web services client 326 and displayed on the user interface 124 without user interaction. The file transfer client 334 may request and receive files from the file server 224 using a protocol such as the File Transfer Protocol (FTP), WebDAV or variant thereof via the client file communications module 206. The server 104 may also include a contention resolution module 219 for managing user permissions and data privacy and contention issues when the application server 212 requests or updates data in the database system 220.

In some embodiments, the server 104 includes connectivity architecture 329 comprising adapters for receiving, filtering, and formatting data feeds from sources external to the system. In one embodiment, an on-site adapter 312 receives data from on-site services 314, via the Java messaging service or other similar messaging service. A second, off-site adapter 316 can receive data from off-site data providers 318 such as FirstCall available from Thompson Financial and Street Events available from CCBN via a standard File Transfer Protocol (FTP) or other file transfer protocols or RSS feeds. In some embodiments, different adapters may be employed for different data sources.

The server 104 may also include, in some embodiments, a component container module 328 such as the Enterprise Java Beans container for storing application components which may be used by the application server 212.

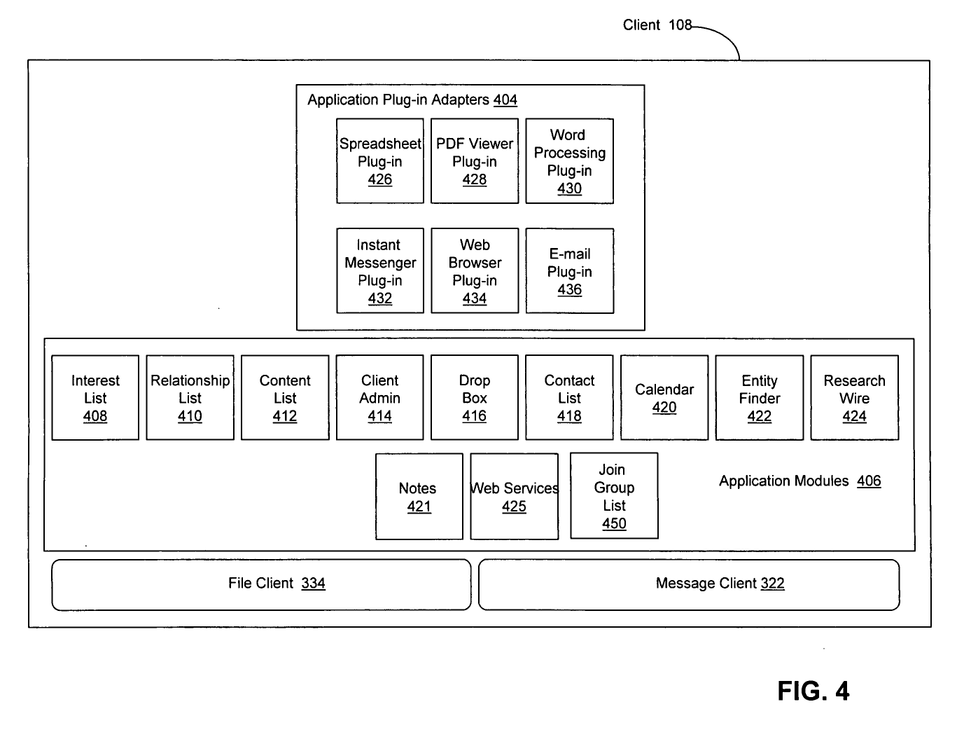

Referring to FIG. 4, in one embodiment, the client 108 includes application plug-in adapters 404 and application function modules 406. The application plug-in adapters 404 (“plug-ins”) facilitate the capture of data, files, content, and other information presented to the user in other commercially available or custom developed software applications that reside on the client 108 or the server 104. Exemplary applications include, but are not limited to, spreadsheet application plug-ins 426 for software such as Microsoft Excel; postscript data format (PDF) viewer application plug-ins 428 for software such as Adobe Acrobat; word processing application plug-ins 430 for software such as Microsoft Word; instant messenger application plug-ins 432 for software such as AOL's Instant Messenger; web browser application plug-ins 434 for software such as Netscape Navigator or Microsoft Explorer; and email application plug-ins 436 for software such as Microsoft Outlook, Lotus Notes, Qualcomm Eudora; as well as adapters for other client-resident applications from which information may be captured. In some embodiments, the plug-in adapters 404 may facilitate capturing information from applications that reside on the server, 104.

In some embodiments, the plug-ins 404 are initiated by selections from a menu or buttons on a toolbar within a client application 122, and in some cases may not require the client software 120 to be operational or to be invoked. For example, a user may receive an electronic mail message with important information regarding a particular entity. In such cases where the toolbar for the user's electronic mail client application has been updated with the email plug-in 436, the user only needs to highlight the desired message (or portions thereof) and click or select the plug-in button. The email plug-in 436 captures the information, and sends it to the file system 216 via the file server 224. Similarly, data being viewed on a World Wide Web content page, as part of a newswire, or from other publicly or privately published documents may be captured and stored in the system using plug-ins adapted for the particular client application 122 used to receive and view the information.

In some embodiments, the client 108 also includes a join group list module 450 that facilitates the creation, viewing, selection and updating of join groups. Join groups allow users to “group” multiple application modules 406, and designate the modules as part of a collection of related modules that are intended to act in concert with each other, as described in greater detail below.

The application function modules 406 facilitate the review, creation, and manipulation of various elements of the system such as information items, personal display and security settings, application defaults, etc. For example, some embodiments may include an interest list module 408 for maintaining one or more lists of topics that may be of particular interest to a user or group of users. Examples of topics that may be included in such a list include companies, financial markets such as the NASDAQ or NYSE, investment vehicles such as bonds or equities, geographic regions such as Japan or the European Union, industries such as computers or automobiles, political issues such as unions or healthcare reform, and the like.

Some embodiments can include an entity finder module 422 for finding or creating an entity to which information may be attributed. For example, a user may be interested in the computer hardware industry, and create entities for the companies that manufacture and sell computer hardware. In some embodiments, the list of entities is pre-populated with a list of companies based on membership in an industry group such as those companies that are listed on a particular stock exchange. In some embodiments, the list of entries can be created by the users of the system.

Some embodiments can include a relationship list module 410 for reviewing and defining relationships between entities. For example, if company A supplies raw materials such as steel or computer chips to company B that company B uses to make its products, a relationship may be defined indicating that company A supplies goods or services to company B. Similar relationships may be created for companies that are competitors, partners, subsidiaries, as well as other business and legal relationships.

Some embodiments can include additional application modules such as a content list module 412 for reviewing information pertaining to one or more entities; a client administration module 414 for facilitating the customization of the user interface 124 for individual users; a drop box module 416 which allows users to easily associate a file or partial content from a file with a particular entity; a contact list module 418 for maintaining information about people from whom one or more users of the system receive information; a calendar module 420 for listing dated events pertaining to entities such as earnings announcements or product launches; a notes module 421 for allowing the creation, storage, and sharing of user-created notes; a research wire module 424 for reviewing information such as research reports published by financial analysts; and a client web services module 425 to facilitate the synchronous request/response of data on the server. In addition, an asynchronous interface composed of a messaging client and a messaging server, for example a Java Messaging Service client/server pair, facilitate the asynchronous update of data residing on the client 108 as it is updated on the server 104 and exposed using the web services module 324 residing on the server 104.

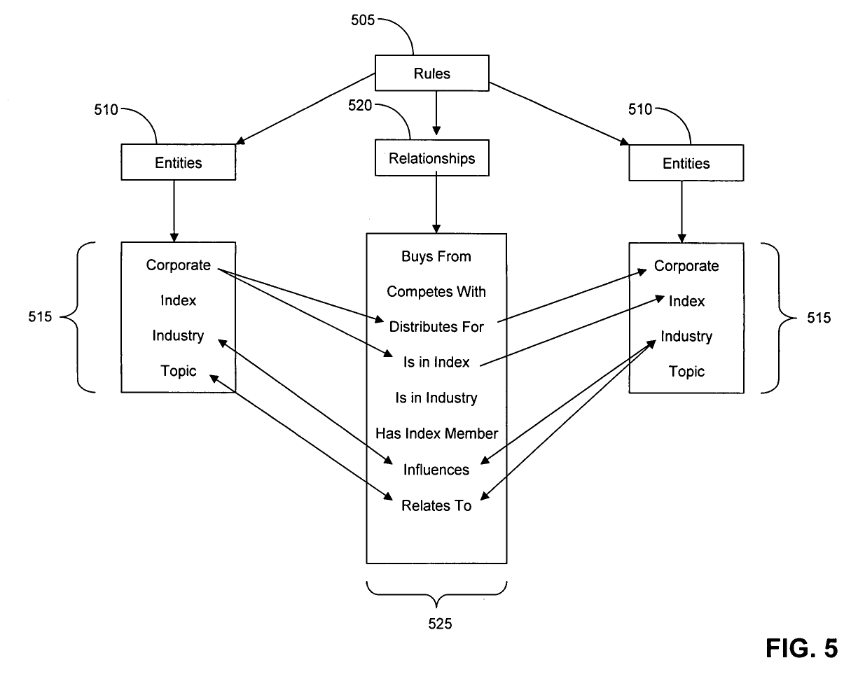

Referring to FIG. 5, in one embodiment, a set of rules 505 govern the creation of the entities 510, the type of entities 515 that can be created, the creation of the relationships 520, the types of relationships 525 that can be created, and which relationships may be used to link entities of a given type. In one embodiment, the rules 505 can describe the entity types 515 that can be created. For example, the rules 505 can specify the entity types 515 as “corporate” entities representing companies, “index” entities representing groups of publicly held companies used to calculate a market statistic, “industry” entities representing a specific area of commerce, and “topic” entities representing subjects that may impact other entities. In another embodiment, the rules 505 can specify the relationship types 525 that can be created. For example, the rules 505 can specify the relationship types 525 as the relationship types listed in Table 1 below.

TABLE 1
Relationship Types
Relationship Type

Buys from
Competes with
Distributes for
Distributes through
Has subsidiaries
Is a subsidiary of
Is in index
Is in industry
Is supplied by
Partners with
Sells to
Has index member
Has industry member
Influences
Relates to

In one embodiment, the rules 505 govern the relationships that one entity type may have with other entity types. For example, a corporate entity may have different relationships with other corporate entities than it would have with an index entity or a topic entity. Table 2 below contains one possible listing of relationship types and the rules associated with how they can be used to relate different entity types. It should be noted, however, that these exemplary relationships represent one particular set of relationships that may be implemented in a specific embodiment of the invention. Additional relationships used to describe the associations of entities with each other may be obvious to those skilled in the art of analyzing the performance of a company, an industry, or other similar entity.

TABLE 2
Relationship Rules

| | | Allowable Related |
|---|---|---|
| Entity Type | Relationship Type | Entities |
| Corporate | Buys from | Corporate |
| Corporate | Competes with | Corporate |
| Corporate | Distributes for | Corporate |
| Corporate | Distributes through | Corporate |
| Corporate | Has subsidiaries | Corporate |
| Corporate | Is a subsidiary of | Corporate |
| Corporate | Is in index | Index |
| Corporate | Is in industry | Industry |
| Corporate | Is supplied by | Corporate |
| Corporate | Partners with | Corporate |
| Corporate | Relates to | Topic |
| Corporate | Sells to | Corporate |
| Index | Has index member | Corporate |
| Index | Relates to | Topic |
| Industry | Distributes through | Industry |
| Industry | Has industry member | Corporate |
| Industry | Is supplied by | Industry |
| Industry | Relates to | Topic |
| Topic | Influences | Corporate |
| Topic | Relates to | Topic |

For example, if a user created an entity to represent a corporation which is listed on a particular stock exchange and that sells its products to another corporation, the rules 505 may permit the user to create an “is in index” relationship to an entity of type “index” and a “distributes for” relationship to an entity of type “corporate.” In addition, the user may create an entity for an industry such as “healthcare” and a relationship to another industry such as “insurance.” However, to maintain the integrity of the system, the rules 505 may prohibit certain relationships based on the entity and relationship types—e.g. the rules 505 may prohibit an “is in index” relationship between an industry entity (healthcare) and an index entity (NYSE) because industries are not listed on stock exchanges. Unlike systems with static lists of entities, a system that allows users to create, modify, and delete entities and the relationships between them, and to have these changes distributed across multiple users in real time provides a greater degree of flexibility to analysts. Such a system can focus on those industries or aspects of investment opportunities that are important to a given organization, maintain knowledge when people leave, and evolve as industries, companies, and investment opportunities grow and change.

In some embodiments, the relationships that connect the entities propagate across multiple entities—that is the same relationship linking a first entity to a second entity also can be the same type of relationship that links the second entity to a third, and so on. By providing such a feature, both direct relationships (entities connected by one or more relationships) as well as indirect relationships (entities separated by one or more intermediate entities, but otherwise reachable through multiple “hops,” thus creating a chain of relationships) can be modeled. Two possible categories of propagating relationships include hierarchical and influential. In some cases, the relationships are reciprocal, i.e. a certain relationship type from entity A to entity B by definition implies a related or “reciprocal” relationship from B to A. For example, a series of propagating hierarchical relationships may be used to describe a large industry, a sub-industry, and a further specialized market within the sub-industry using the “has industry member” relationship and its reciprocal relationship “is in industry” among the hierarchical industry entities.

As an illustration, the automobile industry may have a “has industry member” relationship to a “truck industry” entity, which in turn may have the same “has industry member relationship with a “light truck industry” entity. Moving back from “light truck industry” the relationships would indicate that the subordinate entity is related to the parent industry by an “is in industry” relationship. In this example, the “light truck industry” has an “is in industry” relationship with the “truck industry.” Similar hierarchies can be represented for indices, for example, where a company's stock is a component of a market index. For example, an analyst that follows a market index such as the NASDAQ index may be interested in information items associated with companies such as Microsoft, Cisco, and others. By creating an “is in index” relationship from a Microsoft entity to a NASDAQ entity, and a reciprocal “has member” relationship from NASDAQ to Microsoft, results of requests for information associated with NASDAQ can also include information associated with Microsoft. Likewise, a particular equity or other investment vehicle can be directly or indirectly related to a mutual fund, hedge fund, or other actively or passively managed investment portfolio. By creating hierarchical relationships that span multiple entities, information items that provide valuable information to an analyst but that are associated with entities that are three or four relationships removed from the focus entity can still be retrieved.

Similarly, an influential relationship type describes relationships among entities that can influence each other, and is also reciprocal. Where a first entity influences a second entity, and an “influences” relationship connects the two from the first entity to the second, a reciprocal “is influenced by” relationship connects the same two entities in the opposite direction—e.g., from the second entity to the first. For example, a series of influential relationships can be used to connect entities representing political issues, world leaders, legal issues, and geographic regions: in a particular example, an entity representing “Bush Administration” has an influential relationship with an entity representing “Energy Policy” which in turn has an influential relationship with a third entity representing “Middle East Policy.” Like the hierarchical relationships, the reciprocal nature of the influential relationships provides bi-directional relationships among the entities. Using the above example, where the entity “Bush Administration” is related to the entity “Energy Policy” through an “influences” relationship, the reciprocal “is influenced by” relationship can describe the relationship from the “Energy Policy” entity to the “Bush Administration” entity. Furthermore, because some entities have stronger influences on other entities, the relationships may be further annotated with an “influence factor.” For example, an analyst may believe that the Bush Administration is highly influential on a Middle East Policy entity, but in contrast, only slightly influential on a “Tort Reform” entity. The ability to traverse across multiple relationships and include many entities in a set of entities that are potentially influential on a particular entity of interest can result in the retrieval of a larger collection of information items, including those that may not have been associated with the entity of interest, but valuable nonetheless. This large collection provides an analyst an exceptionally broad view of a market, an industry, and world events, which may in turn lead to better decisions regarding investments.

A user's interaction with the system generally centers around a particular entity (or sets of entities) described herein as the current “focus” of the user. As the user's interest changes (e.g., because she received new information, or was instructed to research a new opportunity), she may change her focus in the system by updating one or more parameters associated with a module of the system or an application embedded within the system (e.g., a URL in a web browser) or by selecting an item from a list (e.g., a folder on a file server using a folder-based operating system or within applications that support foldering such as commonly-available email clients). However, because news, pricing, rumors, and correspondence are typically received simultaneously for any number of entities (including, in many cases those not currently being researched), the focus of her research may change often and rapidly. As a result, she may navigate to and review hundreds of individual information items per day. In instances in which she is attempting to review a large number of information items to research a potential trade for example, the time it takes to update the various applications (and potentially multiple instances thereof) and review the relevant data can be longer than the time frame in which the trade is desirable.

In one embodiment, a web browser application may be embedded within the system, thereby allowing the user to take advantage of information items provided by any number of web sites to assist her with research. However, the number of different sites and pages that include potentially relevant data can be numerous, and often use different navigation techniques to request entity-specific pages. For example, the user may refer to five different websites to research a particular trade, and each website may include a dozen individual pages of interest. As a result, when she shifts her focus to a new entity, she would typically need to navigate to and request sixty different pages to cover all of the web-based resources used to monitor the entity of interest. In addition, other applications (e.g., data feeds, contact lists, notes, etc.) may also include information items of interest while she contemplates a trade or investment, and therefore each application providing the needed information must also be updated if she is to obtain comprehensive coverage of the entity.

To facilitate the automated and coordinated updating of pages rendered by web browsers embedded within the system based on her current focus, individual browser instantiations can be directed to a particular web page (or instantiation of that page incorporating parameter-driven content) by using one or more parameters such as a stock ticker, a topic of research, or a name. The browser application may be embedded within the client software in some cases, or may operate separately and communicate with the client software and/or server using standard inter-process communications. However, unlike a traditional use of web browsers in which users must either provide complete URLs, navigate through a site and find a form in which to enter a parameter, or locate a particular link in order to navigate to a particular site or return query information, the browser is directed to a particular web page (or instantiation of that page incorporating parameter-driven content) based on the focus of the user as determined from the status of another application, system module or another instance of the web browser. In practice, when a user changes “focus” in one module by requesting contact information from an electronic contact list or providing a name to a search engine, for example—modules within the application retrieve the information related to the focus topic without additional user input. This functionality may be extended to external resources such as the Internet by automatically providing the parameter(s) directly to the external resources (e.g., the servers providing content being viewed in the various browser instances) without additional user input. This allows the user to direct the behavior of multiple applications, application instances, or modules within an application using research oriented commands instead of abstract address structures, application commands, or having to physically select application objects.

Conventionally, requesting financial research data for a company (e.g., IBM) from a site such as Yahoo! Finance requires a user to navigate to the Yahoo! Finance web page (http://finance.yahoo.com), enter the ticker symbol for IBM (IBM) into a text search box, and click the “Search” button. The browser then sends an HTTP request to the Yahoo server, and receives the appropriate web page (i.e., http://finance.yahoo.com?q=ibm). While sufficient for casual users of parameter-driven web sites such as search engines, these steps are cumbersome and time consuming for an analyst that is simultaneously receiving multiple information items, reviewing numerous data screens and is expected to make quick, but well-informed decisions.

To relieve the user of such a burden, the invention allows users to define a “pattern” for applications that may be used upon initiation of the application and/or a change in user's focus in the current application or other modules or applications linked to the current application. Because financial research analysts and portfolio managers typically think about and refer to companies of interest by ticker symbol, most financial research web sites allow for navigation by ticker, and thus most relevant financial sites can be described using a token-based pattern.

As one example, the system facilitates the definition, storage, updating and processing of information regarding URLs and their associated query structures. The list of URLs and their query structures may be stored, for example, on the central server in the research system. In some embodiments, web browsers embedded within the client software may be assigned a default URL, which in some instances can be manually changed to use any of the available pre-defined URLs. The URL of an embedded web browser can be persisted as part of the user's application preferences (e.g., desktop layout, startup options, etc.) such that the URLs are automatically initiated upon application startup. Thus, the research application constructs a URL that requests data from a web site (such as a search engine, for example), for a particular topic of interest without the user having to provide the topic to the website. In another embodiment, the research system is configured to access a web page for the search engine, obtain an HTTP form from the search engine, and complete the form with the request for information. In this embodiment, various parameters and their values are encoded in the stored URL and are used to automatically fill the form and submit it. By automating the completions and submission of parameter driven URLs, the system relieves the user of the burden of having to remember and enter each URL and the associated parameters, and provides “directed browsing” of web sites. As used herein, directed browsing refers to the ability to control the actions of an application (e.g., a web browser) by entering short, user-defined “tokens” that, in some instances, are also used to identify entities in the entity database.

One example of a pattern definition includes a URL and a user-defined token representing one or more parameters that are submitted with the URL. More specifically, the pattern may include the token “[Ticker]” referring to a ticker symbol for an equity that is replaced with the focus entity's ticker symbol when the user changes focus to the new entity. In some cases, multiple tokens can be used (e.g., tickers, date parameters, language preferences, refresh rates, browser-specific parameters, etc.). Automatic parsing of patterns using various information extraction technologies may be employed to identify individual tokens or markers within a URL string. For example, a web site addressed using a URL with a string of a single question mark, an equal sign, and then the token, the “?=” pattern can be used to identify where the token is to be placed prior to submission of the URL to the web site. Similarly, a token such as “[user]” representing the user's ID in the system can be placed in a URL that would typically require a username, for example. Additional tokens facilitate the incorporation of more information from the current user, the contact or entity in focus, user preferences, application settings, and other pertinent data.

In some embodiments, individual users can create and edit patterns for their own use, and in certain instances (e.g., where security and/or group-level user attributes are employed) the patterns may be shared with other users. In cases where a web site's syntax has changed (due to a site redesign, for example) the patterns can be erased and/or changed. In cases where multiple patterns exist for a particular site, a system administrator may also erase or edit patterns globally, thus alleviating the users' need to monitor sites and update the patterns.

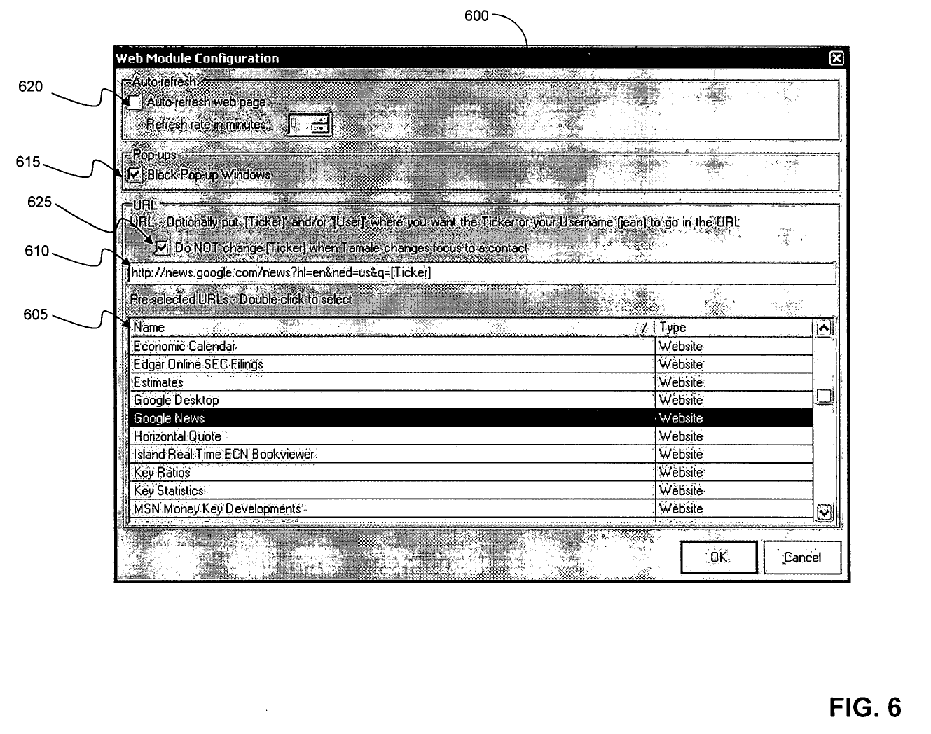

FIG. 6 provides one example of an application screen 600 for defining application commands that facilitate directed browsing of web sites. The screen includes a list 605 of web sites that have been defined in the system. When a user selects a web site from the list, the details for that site (i.e., the URL, one or more parameters that can be passed to the web site server with the URL and any user-defined tokens) are presented in a URL detail text box 610. In some cases, the users may edit the elements presented in the URL detail text box 610, whereas in others the URL is read-only. In some embodiments, portions of the URL are editable, thus allowing a user to add or edit the tokens, but not the base URL. The screen 600 also includes a pop-up blocker check box 615 that permits the user to indicate that pop-up windows are to be suppressed for that URL, as well as an auto-refresh check box 620 that, when selected, provides instructions to a browser application to periodically (e.g., every n seconds) resubmit an HTTP request to the web site server to obtain updated information.

In some embodiments, the client software used for obtaining and reviewing information items includes multiple modules. A module, as used herein, refers to an instance of an application window or screen area that performs a specific function (or functions) related to the workflow of the user. For example, an application may include a calendar module, a contacts module, and/or a notes module. A user may initiate multiple instances of the same module (e.g., multiple notes screens) to simultaneously view information items related to different entities. In some instances, modules may be linked together in a “join group.”

The client software may be implemented as one or more modules of a research and knowledge management application that supports groupings of multiple modules as a collection of related modules that are intended to share a current focus—thus creating a “join group.” Furthermore, users can define multiple instantiations of an application (e.g., multiple web browsers and/or tabs within a browser application) which can be selectively added to a join group, allowing the user to retrieve numerous pertinent web resources simultaneously with a single token or selection entry. In addition, the system supports tabbed windows within embedded browser application, thus allowing multiple simultaneous instantiations of the web browser, with each instantiation being addressed to different sites and/or different representations of the same sites that are responsive to the entry of a ticker symbol, contact name, or other code that indicates the user's desired focus. As a result, multiple web pages may be opened and pointed to the ticker of interest in the time it takes to open one.

For example, a user looking for a summary overview of a company may use a first web site (e.g., http://www.hoovers.com) by entering the ticker symbol for the company of interest. In addition, she may also wish to see recent news items for the same company using a news service, such as the Google News website, download quarterly and annual reports from a corporate reporting website (e.g., http://www.10kwizard.com) and download current financial statistics from Yahoo Finance. By designating each of the browser windows as a member in a “join group” each instantiation of the browser application remains active and points to the company currently being researched, even though the analyst only provided the ticker symbol to the first website. As a result, the user avoids having to manually update the URLs for each active browser instantiation.

In some instances, form data protection is provided for web pages that the user does not want to be refreshed upon changing focus. For example, if a user prefers one browser window to remain focused on a particular entity (e.g., a market index such as NASDAQ) regardless of the current focus or any changes to the focus, she may indicate that browser window (or a particular URL) as “protected” from refreshing when his focus changes, even though the browser is part of a join group. In some embodiments where the user has previously provided data in a form entry field on the web page, the change in focus can be paused and a secondary window (e.g., a drop down menu with various options) may be presented, allowing her to halt the refresh of the page, refresh with the new focus, or refresh with the data previously provided (which may be different than the current focus). In addition, join groups (or individual members of a join group) may be prevented from switching focus from one type of an entity (e.g., a company) to another type of entity (such as a contact). For example, the screen 600 also includes a check box 625 that, when selected for a particular URL, allows for users to change focus to a contact without updating the focus of the particular URL. This may be beneficial in instances where a user wishes to scroll though or select contacts from their personal contact as she receives data and information regarding an investment opportunity without changing the focus of her research.

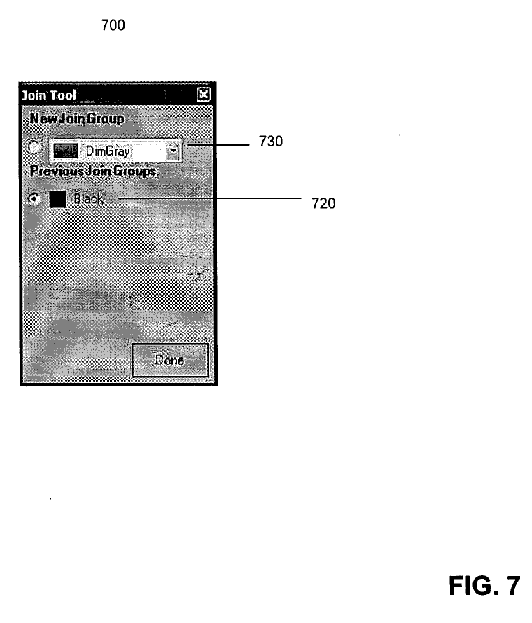

Referring to FIG. 7, in one embodiment, a join tool 700 may be used to group application function modules together as described above. In one embodiment, the join tool 700 provides instructions to the user on how to join application function modules. For example, if the entity finder module and the research wire module were grouped using the join tool 700, and the user changed the selected entity in the entity finder module from General Electric to IBM, the data presented in the research wire module would be updated with data pertaining to IBM.

The join tool 700 may also provide multiple join groups. For example, a user may select certain application function modules to be part of a first join group and select others for inclusion in a second. A drop down box 730 allows the user to select a color to be associated with the group and displayed along the band at the top of the application function modules in each group to provide a visual cue as to which modules belong to which groups. By identifying each group using the colors 720, a user may easily identify those modules grouped together while looking at the work area, which may contain numerous application function modules, some of which may be grouped and others which may not. This provides the user with a work area that is synchronized across application function modules, but only to the extent desired by that user or team of users. The join tool 700 also provides a listing of previously defined groups, and the colors associated with each group 720.

Join groups may be stored, for example as an XML table listing all (or some defined subset) of the join groups. Each join group may be identified by a unique ID, and have attributed to it a unique color used to visually identify the modules as members of the join group. One example of such a table is shown below:

```
<TSSJoinTable>
  <TSSJoinGroup ID=“f0e51331df634ec49211cc7f68e059c7”
  Color=“Green”>
    <TSSJoinModule ID=“05b0c2a31d9e4cbba8597492c2e626ca” />
    <TSSJoinModule ID=“6ef2246b54654130b846072310b9be82” />
    <TSSJoinModule ID=“d2a9b48b50f54f93939687a0dc3658e0” />
    <TSSJoinModule ID=“7ace17e8854d48c9bc105bffb2cf81ad” />
    <TSSJoinModule ID=“22db84e1070547b69f69e974d46871db” />
    <TSSJoinModule ID=“04ddbc81a05c42aabb6158b80da579d4” />
    <TSSJoinModule ID=“053a758cfe46464797deccd2777a0b25” />
  </TSSJoinGroup>
</TSSJoinTable>
```

The XML table may also be stored as part of the user's layout and thus configured and persisted on an individual user basis. In some embodiments where groups are shared, the layout may be attributed to a group of users, thus reducing the need to store the group definition table for each user of the system.

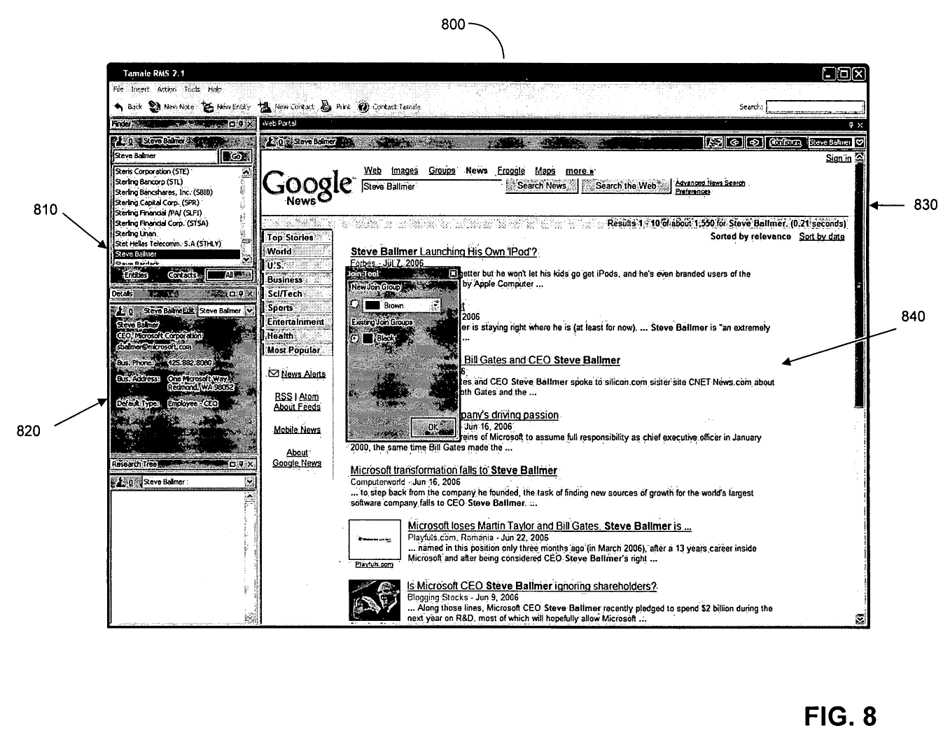

FIG. 8 provides an illustrative application screen 800 presented to a user while performing research on Steve Ballmer using the join group feature. Initially, the user selects the name “Steve Ballmer” from a module of the system—in this case an internal contact database 810. In another example, the user may enter the term “Steve Ballmer” in a text box, or select the name from an information item such as an email, a press release or a research report. In response to the user selection, the application retrieves the contact information 820 as well as other information regarding Steve Ballmer. In parallel, the focus of an embedded web browser 830 is updated with a web page 840 relevant to Steve Ballmer without user interaction. As one example in which the web browser 830 currently displays a search engine home page (e.g., Yahoo, Google, MSN, etc.), the browser receives the term “Steve Ballmer” from the research system and submits an HTTP request including the token to the search engine server. The search engine server then processes the request and returns a web page 840 with relevant search results for Steve Ballmer. Because the user typed “Steve Ballmer” into a textbox of a module that was active at the same time as the web browser, and the module and web browser belonging to a common join group, the browser's focus changed automatically. Thus, the user is not required to enter the URL for the search engine, enter data into text boxes on the search engine home page, or submit the search to the search engine.

In addition to providing entity and/or topic-based focus and browsing, integrating a web browser as a module within the system facilitates quick access to information from lengthy web sites (e.g., sites in which there is a signification amount of information “below the fold” that is not visible when scrolled to the top of the screen). In such cases, the position of the scroll bars (horizontal, vertical, or both) for a particular site may be stored as a position parameter for the application (and in some cases a particular site or document viewed using the application) belonging to a join group. In some cases, the position parameters are stored for each instantiation of the browser in a layout/configuration file. Thus, when a screen is refreshed (either manually or automatically using either a new topic of focus or the same focus), the screen automatically scrolls to the last recorded horizontal and vertical position.

In addition to the use of tokens and join groups for directed browsing and information retrieval, in some embodiments “link commands” may be created that allow web-based applications (e.g., browsers receiving and processing HTTP commands) to automate and control the actions and behavior of a target application, multiple applications, or modules within applications, each of which may or may not be web-based. For example, link commands may be expressed as a URL that, when submitted to a server, both changes the focus of one or more application modules (to a new topic or new information item, as examples) and provides an application command to be executed by the target application once the desired content is retrieved. In one embodiment, a link command URL includes an application command and one or more arguments. Links can be embedded in any HTML page using, for example, standard anchor tags such as <a> and </a>. One example of a possible syntax for link commands is shown below:

<otherURL&>hostname:// [command]<?arg1=val1&arg2=val2...>

where:

```
    <otherURL&> is a URL of a website of interest to the user or group
of users followed by the URL argument delimiter “&”;
    hostname:// is a protocol designation that specifies this URL is to be
interpreted as a link command for the host application;
    command is the command to be presented to the application module;
    argn is the nth argument specific to the command to be executed; and
    valn the value associated with the nth argument.
```

One example of an application command, “nav” instructs the target application to navigate to a particular site using one or more values using, for example, a ticker symbol, a contact identifier, or any other uniquely identifiable data element. Another example of an application command is the “edit” command, which instructs the target application to open the requested document or item in a mode such that the user can subsequently edit the file. As a result, a user can automatically be presented with the appropriate file (by including the “nav” command) and the application in which the file is presented will be presented in the edit mode (by including the edit command). Content rendered in the embedded application can then be navigated as if the user had explicitly directed the application to retrieve the desired item, and active components within the individual application instances (e.g., JavaScripts, ActiveX objects, etc.) behave as expected.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method for retrieving data, the method comprising:
receiving from a user via a first application instance, a topic of research;
identifying a token associated with the topic of research; and
automatically communicating to a second application instance a command string comprising the identified token, thereby facilitating the automatic retrieval of information using the second application instance related to the topic of research.

2. The method of claim 1 wherein the first application instance is a first instantiation of a browser application.

3. The method of claim 2 wherein the second application instance is a second instantiation of a browser application.

4. The method of claim 2 wherein the second application instance is a first instantiation of an application other than the browser application.

5. The method of claim 1 wherein the first application instance and second application instance are instantiations of different applications.

6. The method of claim 1 wherein the topic of research comprises a company.

7. The method of claim 2 wherein the token comprises a ticker symbol attributed to the company.

8. The method of claim 1 further comprising automatically communicating the command string comprising the identified token to a third application instance, thereby facilitating the automatic retrieval of information using the third application instance related to the topic of research.

9. The method of claim 8 further comprising created a grouping of applications comprising the first, second and third application instances, such that actions in any one of the first, second and third application instances automatically initiate corresponding actions in other application instances.

10. A method for retrieving data, the method comprising:
in a first software application, defining a plurality of command strings, each command string comprising a URL and at least one token;
identifying, at the first software application, a value for the at least one token in response to a research topic provided by a user;
replacing the token in a subset of the command strings with the identified value; and
transmitting each of the command strings to a respective one of a plurality of instantiations of a second software application, whereby each instantiation of the second software application retrieves data using its respective command string.

11. The method of claim 10 wherein the second software application comprises a browser application.

12. The method of claim 10 wherein the first and second software applications are different applications.

13. The method of claim 10 wherein the token comprises a ticker symbol.

14. The method of claim 10 wherein the token comprises an application command.

15. The method of claim 14 wherein the token further comprises a filename.

16. The method of claim 10 wherein the token is defined by the user.

17. A system for retrieving data, the system comprising:
a database for storing a plurality of URLs, each URL comprising an address and one or more tokens representing a topic of research;
a client communications module for receiving an application command from a user, the application command comprising at least one of the stored URLs; and
an application server for identifying at least one of the one or more tokens, constructing application commands comprising the one or more tokens, and automatically providing the application commands to a software application, thereby facilitating the automatic retrieval of information using the software application related to the topic of research.

18. The system of claim 17 wherein the software application comprises a browser application.
